(19) United States
(12) Patent Application Publication
(10) Pub. No.: US 2010/0135509 A1
(43) Pub. Date: Jun. 3, 2010

(54) Zeleny sonosphere

(76) Inventor: Charles Timberlake Zeleny, Baltimore, MD (US)

Correspondence Address: DUANE MORRIS LLP, Suite 1000, 505 9th Street, N.W., Washington, DC, 20004, US

(21) Appl. No.: 12/292,948

(22) Filed: Dec. 1, 2008

(51) Int. Cl. H04R 25/00

(52) U.S. Cl. 381/182

(57) ABSTRACT

Inverse speaker systems comprise a plurality of individual sound-reproducing elements arranged in a substantially spherical arrangement. These inverse speaker systems are useful for applying sound to a human body.

### FIELD OF THE INVENTION

The present invention relates to an apparatus for applying omnidirectional sound to a human body.

### BACKGROUND OF THE INVENTION

Over the last decades, video games have been a popular form of entertainment for consumers. As the computation necessary to generate advanced full-motion graphics has steadily become cheaper, and algorithms for generating imagery on the fly have become better developed, the average consumer has continued to make regular expenditures of discretionary income to upgrade home video game systems, and play the latest arcade video games. One of the draws of arcade video games and advanced home video games is the level to which the realism of the images enables the player to escape from the real world for a time and enter the fantasy world of the game. The graphics of top arcade games have gone from simple two-dimensional representations, to three dimensional representations with complex shading and textures, and the laws of physics well represented in how the three-dimensional characters and objects in the games interact.

As the video images produced by top video games have taken staggering leaps forward in complexity over the last ten years, the sound tracks of these games have also advanced considerably, though not as much as the video images. This is partly due, perhaps, to the lack of significant advancement in the designs of the speaker systems that deliver the sound to the consumer who is playing the game.

Most speaker systems in arcade video games remain quite similar to those of 10 years ago. These are either simple monaural speaker systems, or simple stereo speaker systems, usually mounted in the cabinet of the video game console, which is usually positioned in front of the consumer playing the game.

As the sound tracks for these video games improve, they are getting closer to the level of quality found in the sound tracks of today's box office hit movies. These movies often contain amazing special effects. A sound track which creates an acoustic experience which “grips” the audience can be a key factor in transporting the audience into the artificial reality being created by the movie. In this vein, top-of-the-line video games will be using sound more and more to create the reality for the player of the game. As this trend continues, audio systems for video games will have to continue to improve in quality.

The reproduction of music, with desirable psycho-acoustical characteristics (such as might be experienced in a concert hall listening to a live performance) has been the objective of many in the audio industry for years. The modern pursuit of this goal has included implementations utilizing digital signal processing for the reconstruction of a sound field by measuring the acoustic response of the field and then modifying the input to an array of loudspeakers to produce the appropriate velocity and pressure within the medium.

Some hold that audio systems should be designed for the “exact” reproduction of a sound field that might be experienced by a listener in a concert hall. The exact reproduction of a sound field can be approached one of two ways.

In the first way, a recording of the sound experience to be reproduced may be made on a binaural recording device which mimics the size and shape of a human head (including the ears). When played back through headphones, such a recording can be strikingly lifelike, with much of the spatial (directional) cues preserved. The disadvantage of this type of recording is that it is so highly optimized for headphone play-back; it does not sound as good as a “regular” stereo recording when played back through speakers which aren't right next to the listener's head. Another disadvantage of headphones is that their use may be cumbersome or impractical in some applications, and headphones used in public applications (such as in CD stores or arcades) are prone to reliability problems.

The second way that one can approach the reproduction of a sound field is to produce a sound field with multiple speakers placed at different points in space, and fed different signals (hereinafter referred to as a “multi-channel” audio system). Stereo is the simplest such commonly employed approach. Such psycho-acoustic parameters as perceived “depth”, “spaciality”, “color” and “timbre” are generally agreed to be much improved in a stereo sound system, as compared with a monaural sound system. Driver characteristics such as linearity and frequency response also affect the perceived quality of the signal.

Sound systems with more than two speakers also exist (though they are not as widely used as simple stereo). Such systems include Dolby Surround-Sound (used in theaters), and earlier attempts at “quadraphonic” standards. The problem in designing multiple-speaker systems beyond simple stereo is choosing a trade-off in the number of transducers, the placement of those transducers, the design of those transducers, and the signals fed to those transducers to economically produce a “desirable” psycho-acoustical effect.

Trying to recreate a standard audio bandwidth (20 Hz-20 kHz) sound field to arbitrary accuracy throughout a room is a totally impractical problem. As detailed in a publication by Nelson, P. A., 1994, “Active control of acoustic fields and the reproduction of sound,” Journal of Sound and Vibration, 177(4), pp. 447-477, to identically reproduce a sound field with an array of transducers over a frequency range extending from 20 Hz to 10 kHz and for a sphere of 10 m diameter would require over 1 million individual sources.

Fortunately, the human auditory system is not measuring “everything” about the sound field. Some is known about what “key” things contribute to perceptions (such as “this sounds ‘real’, and this doesn't”), and a lot is still not known. An exciting opportunity exists in the field of audio to discover and design systems which, while much simpler than the above described one million transducers, provide highly desirable psycho-acoustical effects at reasonable prices, and are thus valued by consumers.

In the past ten years, signal processing, and in particular, digital signal processing has allowed for the most significant breakthroughs in the quest for more psycho-acoustically pleasing sound reproduction. The quest for “accurate” reproduction of sound is ironic in some ways. Many have been assuming the need to accurately reproduce something, yet concert halls with the same (accurate, live, “real”) sources in them have vastly different perceived qualities, even with no distortion. Taking this into account, one could hold that an ideal audio system could create new realities (or acoustic environments), not just reproduce known ones. Some of today's digital signal processing units have taken a cut at creating part of the reality (as the concert hall does). Digital signal processing audio units cannot, however, overcome some of the basic physical limitations imposed by the speakers attached to them, such as the physical positions of the speakers in the room and their directionality (radiation patterns) at different frequencies.

The term “virtual reality” has been used to describe a computer-generated environment. This represents the next level of video gaming and entertainment. When viewed with special goggles or head-mounted display, virtual reality provides the user with a three-dimensional, fully interactive experience. A hand-held grip can be used to achieve movement or navigation within the environment. As the user turns his or her head, the view can change just as it would in reality. Buttons on the hand-held grip permit the user to experience movement from one location to another, thus adding a sense of reality, to virtual reality. The technology used to produce virtual reality generally consists of a graphics-generating computer, a head-mounted-display with a tracking device, a hand-held grip, and other sensory input devices. Various products may be used to achieve the experience of virtual reality (Pimentel, K. and Teixeira, K. 1993, Virtual Reality: through the new looking glass. Intel/Windcrest/McGraw-Hill, Inc. New York).

However, none of the known virtual reality systems includes a suitable means for distributing sound around a user in all directions and in all dimensions. Rather, at best, these known systems use directional speakers and/or headphones to try and localize and direct sound to the user. Unfortunately, because of this deficiency, the virtual reality experience is diminished. There is therefore a need for a device that can uniformly direct sound at a user from all directions.

### SUMMARY OF THE INVENTION

It is therefore an object of the present invention to provide an apparatus that overcomes some or all of the problems associated with known devices, in particular the localization and/or direction of sound waves. Other objects, features and advantages of the present invention will be set forth in the detailed description of preferred embodiments that follows, and in part will be apparent from the description or may be learned by practice of the invention. These objects and advantages of the invention will be realized and attained by the apparatus and methods particularly pointed out in the written description and claims hereof.

In accordance with these and other objects, a first embodiment of the present invention is directed to an inverse speaker system comprising a plurality of individual sound-reproducing elements having a substantially spherical arrangement defining a cavity having a diameter sufficient to accommodate at least one human body without said body contacting any of said sound-reproducing elements.

A second embodiment of the present invention is directed to an apparatus for the application of sound waves to a human body. Such an apparatus comprises an inverse speaker system as described above operably connected to an adjustable external support frame which can position the plurality of individual sound-reproducing elements in any desired orientation with respect to the external environment. Optionally, such an apparatus may also include a motor for changing the position of the sound-reproducing elements of the inverse speaker system relative to the external environment.

A third embodiment of the present invention is directed to an apparatus for creating a virtual reality experience. Such an apparatus comprises an inverse speaker system as described above operably connected to: (i) an adjustable external support frame, including a motor for changing the orientation of the speaker system within the support frame; (ii) means for producing a visual image for a user, such as an LCD monitor or virtual reality goggles; and (iii) at least one computer processor (for operating the inverse speaker system, the motor and/or the means for producing a visual image).

It is to be understood that both the foregoing general description and the following detailed description are exemplary and explanatory only and are intended to provide further explanation of the invention as claimed.

### DESCRIPTION OF THE DRAWINGS

The invention will be more readily understood from a non-limiting description of certain preferred embodiments that follows and from the diagrammatic figure of the drawings.

FIG. 1 shows a schematic diagram of one embodiment of the present invention (Zeleny Sonosphere CE-302A);

FIG. 2 shows a schematic diagram of another embodiment of the present invention (Zeleny Sonsosphere-R CE-500).

### DETAILED DESCRIPTION OF THE PREFERRED EMBODIMENTS

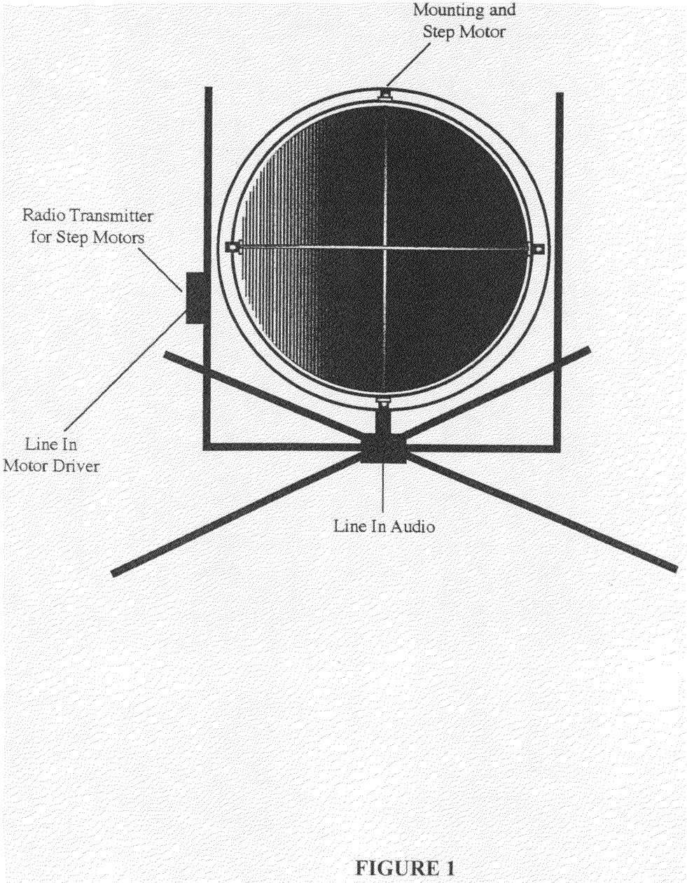

Referring now to FIG. 1, there is shown a schematic diagram for one embodiment of the present invention. As shown in FIG. 1, this preferred embodiment comprises a plurality of individual sound-reproducing elements connected to one another in a substantially spherical arrangement defining a cavity. This cavity is large enough to accommodate at least one human body without it touching any of the sound-reproducing elements. According to certain embodiments, the diameter of the substantially spherical arrangement will be sufficient to accommodate a human adult in a standing position, e.g. a diameter of at least 3 meters, while according to other embodiments, the diameter will only be sufficient to accommodate a human child in a standing position or a human adult in a sitting position, e.g. a diameter of about 2 meters. According to still other embodiments, the diameter will only be sufficient to accommodate a human infant or a human child in a sitting position, e.g. a diameter of about 1 meter.

The individual sound-reproducing elements may be any suitable sound-reproducing structure known and available to those skilled in the art. Suitable sound-reproducing structures, and means for connecting and operating the same, are described, for example, in the following: U.S. Pat. No. 3,636,278 to Heil for “Acoustic Transducer with a Diaphragm Forming a Plurality of Adjacent Narrow Airspaces Open Only at One Side with Open Sides of Adjacent Air Spaces Alternatingly Facing in Opposite Directions”; U.S. Pat. No. 4,056,697 to Heil for “Movable Diaphragm Connector Method Flexible Hinge Diaphragm Surround and Electro-Acoustic Transducer with Folded Diaphragm with Intermediate Positions”; U.S. Patent Application Publication No. US 2004/0052386 to Heron for “Panel Form Loudspeaker”; and U.S. Patent Application Publication No. 2004/0066938 to Heron for “Loudspeaker”. The disclosures of each of these documents is hereby expressly incorporated by reference.

According to certain preferred embodiments of the present invention, the individual sound-reproducing elements may be in the shape of individual strips, each of which comprises a plurality of at least partly vibratory diaphragm portions arranged to define between themselves adjacent narrow airspaces. The strips are connected in such a way that the adjacent airspaces are alternatingly closed and left open at opposite ends. Such strips are preferably long enough to reach from one pole of the inverse speaker system to the other pole. Alternatively, the strips may reach from a pole of the inverse speaker system to the mid-point, or equator, of the substantially spherical arrangement. Each strip also includes means for transforming vibrations imparted thereto by electric energy into sound waves. The strips are connected to one another in such a manner as not to interfere with the production of sound waves thereby. Suitable connecting means are known in the art.

According to other preferred embodiments of the present invention, the individual sound-reproducing elements may be in the form of pentagonal and hexagonal panels. Such panels may be of any suitable size and dimension, and are preferably arranged in a geometric, “buckyball” fashion. Each of these panels has at least one electromechanical drive means coupled thereto to excite a multi-modal resonance in said panel in response to an electrical input within a working frequency band for the inverse speaker system. Each panel is held in place by mounting means, which supports the panel and/or attaches the panel to a supporting body in a free undamped manner. Suitable mounting means are known in the art.

According to still other preferred embodiments of the present invention, the individual sound-reproducing elements are panels in the shape of hemi-spherical shells. Each of these panels also has at least one electromechanical drive means coupled thereto to excite a multi-modal resonance in said panel in response to an electrical input within a working frequency band for the inverse speaker system and each panel is held in place by suitable mounting means.

Regardless of the shape selected, the individual sound-reproducing elements must be arranged such that a human can enter and leave the internal cavity defined by the individual sound-reproducing elements. The particulars of such will depend on the specific shape(s) employed and so can be determined empirically by one skilled in the art. For example, if the individual sound-reproducing elements are in the shape of individual strips extending from one pole to the other, provision can be made to permit the separation of two strips by a distance sufficient to permit a human to enter the internal cavity of the substantially spherical arrangement, such as by providing a plurality of hinges along an outer edge of the substantially spherical arrangement. Alternatively, if the individual sound-reproducing elements are in the shape of panels, one or more panels may be arranged to be movable to permit a human to enter the internal cavity of the substantially spherical arrangement.

The inventive inverse speaker is substantially spherical, i.e. points on the surface of the inverse speaker system will all be substantially the same distance from a fixed point. Preferably, all points on the surface of the inverse speaker system will be within 10% of a predetermined distance from a fixed point within the internal cavity defined by the sphere. More preferably, all points on the surface will be within 5% of a predetermined distance from a fixed point within the sphere, and even more preferably within 2%. Still even more preferably, all points on the surface will be within 1% of a predetermined distance from a fixed point within the sphere, and most preferably within 0.10%.

According to preferred embodiments of the present invention, the inventive inverse speaker system further comprises means for supporting a human body within the internal cavity of the substantially spherical arrangement.

Such a suitable support may be in the shape of a chair or stool large enough to support the user. The support must be of sufficient strength to remain substantially rigid when subjected to the user's weight. Examples of materials that can be used for the support include, but are not limited to, wood, sound board, plywood, particle board, composite insulation board, plastic, glass, Plexiglas, fiberglass, metal, stone, marble, etc.

The present invention also preferably includes at least one sound generator having plurality of outputs connected to the individual sound-reproducing elements. The sound generator may be any sort of device that generates an electrical output which may be converted into acoustic vibrations. Examples of some types of sound generators include, but are not limited to, stereo systems, radio receivers, phonographs, compact disc players, tape recorders and players, cable box decoders, satellite signal capturing devices, televisions, video cassette recorders, Internet connecting devices, etc. The sound generator may also include either an internal or external amplifier.

Controls for the sound generator may be accessible to the user inside the internal cavity or may be controlled by someone outside. Most preferably, each individual sound-reproducing element may be controlled using a separate control. These controls may be either a specifically designed device or a general purpose computer employing a software program to regulate delivery of the frequency vibrations to the user.

According to certain preferred embodiments, the inverse speaker system of the present invention emits acoustic vibrations within the range of human auditory response. Preferably the sound frequency range produced is from about 10 Hz to about 25,000 Hz, and more preferably sound frequency is from about 30 Hz to about 20,000 Hz.

According to other preferred embodiments, the inverse speaker system emits acoustic vibrations outside the range of human auditory response, for example in the ultrasound range, i.e. greater than 20 kHz, or in the infrasound range, i.e. 0.001 Hz to 20 Hz. According to still other preferred embodiments, the inverse speaker system of the present invention emits acoustic vibration both within and outside the range of human auditory response.

A second embodiment of the present invention is directed to an apparatus for the application of sound waves to a human body. Such an apparatus comprises an inverse speaker system as described above operably connected to an adjustable external support frame which can position the plurality of individual sound-reproducing elements in any desired orientation with respect to the external environment. Optionally, such an apparatus may also include a motor for changing the position of the sound-reproducing elements of the inverse speaker system relative to the external environment. In addition, such an apparatus may also include a shell or housing to contain the inverse speaker system.

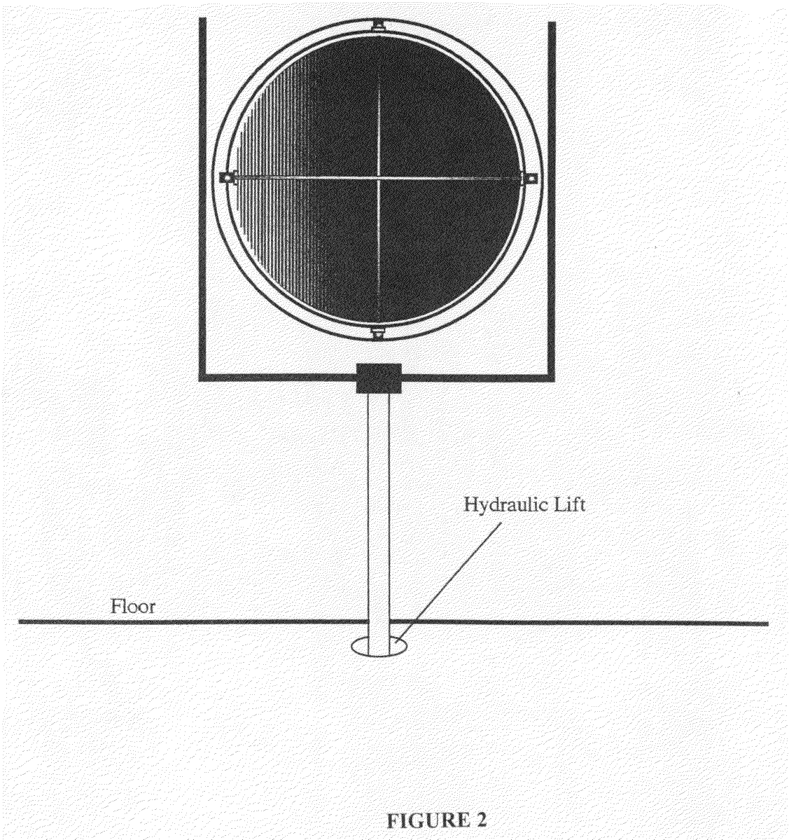

Another embodiment of the present invention is shown in FIG. 2. This embodiment is directed to an apparatus for creating a virtual reality experience. Such an apparatus comprises an inverse speaker system as described above operably connected to: (i) an adjustable external support frame, including a motor for changing the orientation of the speaker system within the support frame; (ii) means for producing a visual image for a user, such as an LCD monitor or virtual reality goggles; and (iii) at least one computer processor operably connected to at least one of the inverse speaker system, motor and means for producing a visual image.

According to certain preferred embodiments, the inventive apparatus may further comprises means for changing the position of the external support system relative to the external environment. Such means may include a hydraulic lift or similar means for causing the external support system to be raised and lowered relative to the external environment. Moreover, according to certain particularly preferred embodiments, the external support frame is a gyroscope.

The foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art.

What is claimed is:

1. An inverse speaker system comprising a plurality of individual sound-reproducing elements having a substantially spherical arrangement defining a cavity having a diameter sufficient to accommodate at least one human body without said body contacting any of said sound-reproducing elements.

2. The inverse speaker system according to claim 1, further comprising an adjustable external support frame which can position said plurality of individual sound-reproducing elements in any desired orientation with respect to the external environment.

3. The inverse speaker system according to claim 2, further comprising at least one motor operably connected to said adjustable external support frame for mechanically adjusting the position of said plurality of individual sound-reproducing elements in a desired orientation with respect to the external environment.

4. The inverse speaker system according to claim 1, wherein each of said plurality of individual sound-reproducing elements comprises a plurality of closely spaced, partially vibratable diaphragm portions arranged substantially parallel to one another and defining between themselves narrow airspaces; and means connected to each of said vibratable diaphragm portions closing each of said airspaces all around with the exception of one side which remains acoustically open, wherein said open sides of adjacent airspaces face in opposite directions.

5. The inverse speaker system according to claim 1, wherein each of said plurality of individual sound-reproducing elements comprises a panel of suitable dimension and stiffness and at least one electromechanical drive means coupled to said panel to excite a multi-modal resonance in said panel in response to an electrical input within a working frequency band for said inverse speaker system.

6. The inverse speaker system according to claim 5, further comprising mounting means which supports said panel and/or attaches said to a supporting body in a free undamped manner.

7. The inverse speaker system according to claim 1, further comprising means for supporting a user within the internal cavity of said substantially spherical arrangement.

8. An apparatus for the application of sound waves to a human body, said apparatus comprising an inverse speaker system according to claim 1 operably connected to an adjustable external support frame which can position said plurality of individual sound-reproducing elements in any desired orientation with respect to the external environment.

9. The apparatus of claim 8, further comprising a motor for changing the position of said sound-reproducing elements relative to the external environment.

10. The apparatus of claim 8, further comprising a shell or housing to contain said sound-reproducing elements relative to the external environment.

11. An apparatus for creating a virtual reality experience, said apparatus comprising an inverse speaker system according to claim 1 operably connected to: (i) an adjustable external support frame, including a motor for changing the orientation of said inverse speaker system within said support frame; (ii) means for producing a visual image for a user; and (iii) at least one computer processor operably connected to at least one of said inverse speaker system, said motor and said means for producing a visual image for a user.

12. The apparatus of claim 11, further comprising means for changing the position of the external support system relative to the external environment.

13. The apparatus of claim 12, wherein said means for changing the position of the external support system relative to the external environment comprises a hydraulic lift.

14. The apparatus of claim 11, wherein said external support frame comprises a gyroscope.
